(19) United States
(12) Patent Application Publication
(10) Pub. No.: US 2015/0011299 A1
(43) Pub. Date: Jan. 8, 2015

(54) Internet golf sweepstakes game

(71) Applicant: Trevor Lucey, La Mesa, CA (US)

(72) Inventor: Trevor Lucey, La Mesa, CA (US)

(21) Appl. No.: 13/987,167

(22) Filed: Jul. 5, 2013

(51) Int. Cl. G07F 17/32

(52) U.S. Cl. CPC G07F 17/329
USPC 463/25

(57) ABSTRACT

A method for running a sweepstake-type game whereby the players seeks to win the sweepstakes by accurately predicting a portion of the result of a golf tournament such as the weekly PGA golf tournaments. In preferred embodiments the sweepstakes players are asked to predict the winner of the tournament and also the golfers who will shoot par on the last day of the tournament. In a preferred embodiment a control computer is able to determine the winners of the sweepstakes quickly enough that their names can be announced as the winning golfer is walking off the 18^{th} green. In preferred embodiments provisions are made so that sweepstakes player can make their predictions directly through the web sites of the sponsors or of the operator of the sweepstakes. The sweepstakes players are required to furnish their name and a unique identifier, such as their social security number, special code or password to control the number of participants and the number of predictions available to each participant to assure that each participant has been authorized to participate in the contest with respect to each prediction.

### FIELD OF THE INVENTION

The present invention relates to facilities for conducting sweepstakes games and in particular to such facilities and games based on results of sports events.

### BACKGROUND OF THE INVENTION

### Sweepstakes Games

Sweepstakes-type games are well known all over the world. These games include lotteries and horserace betting. Sweepstakes are also commonly used to promote the sale of magazines and books. In Europe and Latin America national sweepstakes games based on the outcome of soccer matches are very popular.

### Early 90's Automated Golf Sweepstakes Games

During the early 1990's the Applicant applied for and was granted two patents covering automated golf sweepstakes games. These were U.S. Pat. No. 5,043,889 issued Aug. 27, 1991 and U.S. Pat. No. 5,332,218 issued Jul. 26, 1994. Both of these patents are incorporated herein by reference. In both of these patents equipment was described that would allow many thousands of players to participate in sweepstakes games where the winner of the sweepstakes was based on the accurately predicting the outcome of PGA golf tournaments. Two techniques were described to permit the sweepstakes players to make their predictions utilizing automated computer controlled equipment. In the first technique the players made their predictions by shading in portions of a coupon similar to an IBM card to indicate his predictions. Special card readers were identified that would be made available at sponsors locations that would automatically read the cards and provide the predictions to a master computer that would record the prediction. Players were required to obtain the coupons from sponsors of the sweepstakes as a part of a marketing program. In another embodiment sweepstakes players could make their prediction via touch tone telephone with a call to a computer controlled answering service. In this case a prerecorded audio instruction would guide the player to make his prediction by typing numbers on his telephone corresponding to his prediction.

### The Internet

Since the early 1990's the Internet has become available to the large majority of the people in the world. Most major businesses in the United States have a web site which is used by the business to promote its interests. Web sites can be made interactive so that visitors to the web sites can communicate with the web site computer.

### OBJECTIVE OF THE INVENTION

An object of the invention is to utilize the Internet for conducting a sweepstakes game based on participants predicting a portion of the outcome of golf tournaments. It is an object of this invention to provide facilities that will enable the sponsors of the sweepstakes to evaluate all of the many expected entries using computer equipment so that the winner or winners can be determined quickly and efficiently. Another object of the invention is to develop interest in and promote the products and services of sponsors of the sweepstakes game, golf interests in general and of the advertisers which advertise their products and services in connection with these golf tournaments including television broadcasts, magazines and newspapers. Another object of the invention is to promote golf interests in general. Where laws permit, another object of this invention is to provide a method for efficiently operating a sweepstakes for profit where sweepstakes participants would pay for the opportunity to play the sweepstakes game.

### SUMMARY OF THE INVENTION

The present invention provides a method for running a sweepstake-type game whereby the players seeks to win the sweepstakes by accurately predicting a portions of the result of a golf tournament such as the weekly PGA golf tournaments. In preferred embodiments the sweepstakes players are asked to predict:
1) the winner of the tournament and also
2) the golfers who will shoot par on the last day of the tournament.

In a preferred embodiment a control computer is able to determine the winners of the sweepstakes quickly enough that their names can be announced as the winning golfer is walking off the 18^{th} green. In preferred embodiments provisions are made so that sweepstakes player can make their predictions directly through the web sites of the sponsors or of the operator of the sweepstakes. The sweepstakes players are required to furnish their name and a unique identifier, such as their social security number, special code or password to control the number of participants and the number of predictions available to each participant to assure that each participant has been authorized to participate in the contest with respect to each prediction.

A list of the potential golfers playing in the tournament may be provided on the web sites of the sweepstakes operator and/or the Sponsors. The sweepstakes player logs in to a web site and using a computer mouse, touch screen, smart phone or similar equipment indicates his predictions of the tournament outcome. The predictions are transmitted to a central control computer that organizes the predictions of all of the sweepstakes players. Applicants expect that for a typical PGA golf tournament there may be several million sweepstakes players, so the central control computer must be able to handle enormous quantities of data. Preferred embodiments of the present invention utilize a variety of techniques to establish the criteria for success in the sweepstakes.

In preferred embodiments special codes are computer generated by the sweepstakes operator and tracked in computers of the sweepstakes operator, its sponsors and agents. Sponsors pay a flat fee to the sweepstakes operator and purchase the special codes from the sweepstakes operator at a small price, such as 10 cents per special code. Sponsors can furnish a limited number (typically one each) of the special codes to their customers, clients or potential customers or visitors to their web site free of charge. Potential players in this embodiment can purchase special codes from the sweepstakes operator of agents of the sweepstakes operator at a larger price such as $1.00 per special code. Each special code authorizes one prediction.

### BRIEF DESCRIPTION OF THE DRAWINGS

FIG. 1 lists the PGA tournaments between Jan. 13, 2011 and Jul. 28, 2011 and shows the location, purse, tournament winner, par for the tournament and the number of golfers who shot par on the last day of the tournament.

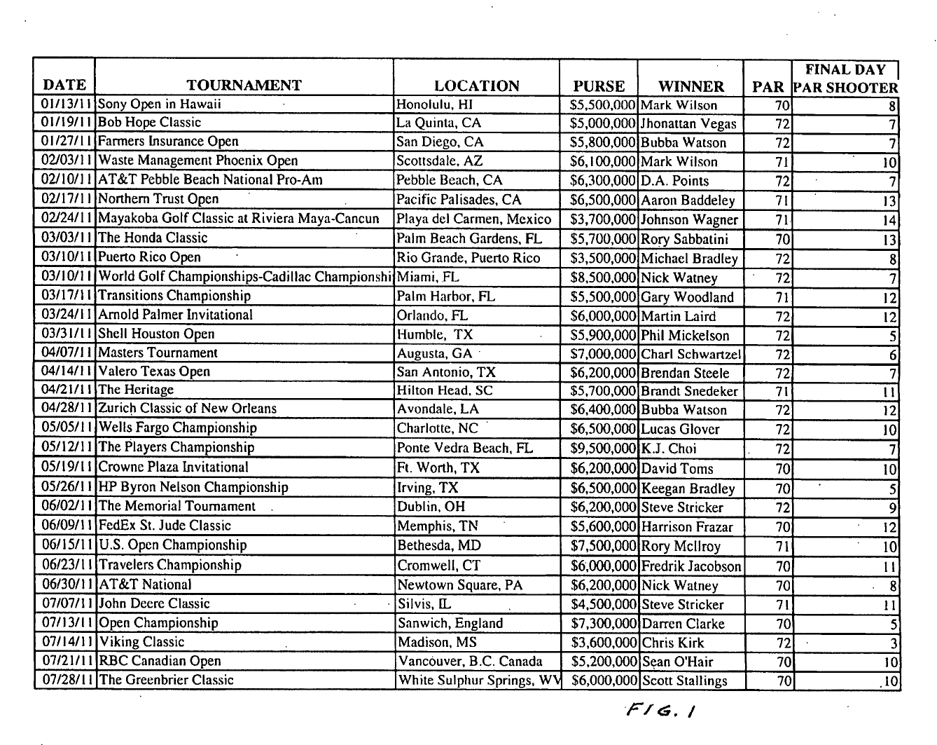

### DETAILED DESCRIPTION OF THE INVENTION

### Par-Golf Sweepstakes

My preferred name for the sweepstakes game which will use the apparatus which is the subject of this invention is “Par-Golf Sweepstakes”. In preferred embodiments an Internet web site is created called “pargolfsweepstakes.com”. This web site is in Internet communication with the web sites of all sponsor organizations. The sponsor organizations may download software from “pargolfsweepstakes.com” which permits pargolfsweepstakes.com to communicate directly with all sponsor web sites. In this embodiment on Wednesday of each week pargolfsweepstakes.com transmits details of the tournament planned for the weekend of that week to each sponsor web site. These details include the names of the participants expected to play in the tournament. These details update the software already available at the sponsor's web site so that sweepstakes players visiting the sponsor's web site can make their predictions for the coming weekend tournament. In a preferred embodiment the sweepstakes players are asked to predict:
1) the winner of the tournament and
2) the golfers who will shoot par on the last day of the tournament.

Predictions by the sweepstakes players are recorded along with the player's name, address, unique identifier, and the time of his prediction. All of the prediction data accumulated at each sponsor's web site is transmitted periodically to the control web site, pargolfsweepstakes.com, where it is organized for rapid analysis during the playing of the tournament. Participants get 10 points for predicting the winner of the tournament and two points for each correct prediction of the par shooters. They lose one point for each incorrect prediction of par shooter. In case of a tie the prize goes to the first of the winners to submit his or her prediction. As an alternative the rules could provide that the prize is shared equally among the winners.

On the last day of the tournament as the players who have shot par become identified, the control computer matches the par shooters and the names of the sweepstakes players who have correctly predicted the names of the par shooters so that when the last group of golfers completes their putting on the 18^{th} green, the control computer is able to identify the winner or winners of the sweepstakes. Preferably, these determinations can be made within a few seconds or minutes after the tournament is over and as suggested above, the winners can be announced to the television audience while the last group of golfers is walking off the 18th green. This aspect of the game will vastly increase the interest of the television audience in the tournament, especially for those participants who have predicted the winner to be a golfer who is still in contention near the end of the tournament.

Preferably, the sweepstakes game will be played on a national and maybe international scale with millions of players and huge prizes. However, this invention can just as well be practiced on a very small scale. For example, a single local sponsor might want to sponsor the sweepstake game for his local customers numbering in the hundreds or thousands. In this case the prizes would be much smaller, but the game can be structured to give the participants a correspondingly better chance of winning.

### Funding the Sweepstakes

In preferred embodiments special codes are computer generated by the sweepstakes operator and tracked in computers of the sweepstakes operator, its sponsors and agents. Sponsors pay a flat fee to the sweepstakes operator and purchase the special codes from the sweepstakes operator at a small price, such as 10 cents per special code. Sponsors can furnish a limited number (typically one each) of the special codes to their customers, clients or potential customers or visitors to their web site free of charge. Potential players in this embodiment can purchase special codes from the sweepstakes operator of agents of the sweepstakes operator at a larger price such as $1.00 per special code. Each special code authorizes one prediction.

### Other Methods of Determining Sweepstakes Winners

There are many ways to determine the winners of the sweepstakes in addition to the one described above. Instead of determining the sweepstakes winner on the tournament results the sweepstakes winner could be based on the results of only the final round. This would mean that entries could be submitted just prior to the playing of the final round. The game could obviously be changed to require the prediction of six, ten or any other reasonable number of par shooters. Prizes could be awarded on many different criteria. For example, in addition to the sweepstakes prize, a lessor prize could be awarded to everyone who predicts the winner and at least two par shooters. Greater prizes could be given to those who correctly predict larger numbers of par shooters.

If the game becomes very large, players could be required to make more precise predictions to reduce the probability of ties. For example additional points could be awarded for predicting the golfers who finish second, third, fourth and fifth, with 8 points for second place, 6 points for third place, 4 points for fourth place and 2 points for fifth place. Correct predictions of ties for third place, for example would receive 10 points. In case of a tie the prize could be divided among the players who tied. Players could be asked to predict the score of the tournament winner and 5 points could be given for a correct prediction. Also additional points, such as 4,3,2 and 1, could be given for correct predictions of the second, third, fourth and fifth finishers. The same point system could be used consistently for all tournaments or the number of points given and subtracted could be changed for every tournament or from time to time.

### Advantages

Applicant believes this invention will provide huge benefits to every aspect of the golf industry, including: the Sponsors, the PGA, golf courses, the PGA golfers and the sweepstakes player.

### The Sponsors

Sponsors are expected to include golf equipment makers and apparel manufacturers. Also golf courses and driving ranges could be sponsors. Other potential sponsors include high end automobile manufacturers, insurance companies and other corporations that typically sponsor the golf tournaments. Each sweepstakes player who visits a sponsor's web site to make a predication can be provided with information from the sponsor about the sponsor and its products or services. The cost to the sponsor will only a fee paid to the sweepstakes promoter. To give sweepstakes player an incentive to utilize the web site of a particular sponsor, the sponsor may choose to offer additional prizes to players who utilize the sponsor's web site.

### The PGA

This sweepstakes game will make the weekly PGA tournament much more popular. It should greatly increase the number of television viewers and exposure for their advertisers.

Sweepstakes players will become much more familiar with the names of the professional golfers and the players will watch carefully the scores of the golfers on which the players have made predictions.

### The PGA Golfers

The PGA golfers will become much more popular. The average players will become better known because it will be the average players who are much more likely to shoot par than win the tournaments. Sweepstakes players will begin to focus as much attention on who is going to shoot par as who is going to win the tournament.

### Sweepstakes Players

The players who have made predictions will find the weekly tournaments much more interesting in that they will have a chance of winning valuable prizes.

It is to be understood that while certain forms of the present invention have been illustrated and described herein, it is not to be limited to the specific forms or arrangement of parts described and shown.

What is claimed is:

1. A method of conducting a sweepstakes game by a sweepstakes operator utilizing a communication network and a plurality of web sites of sweepstake sponsors, wherein the winner of the sweepstakes is a player in the game who correctly predicts a portion of the results of a golf tournament, such method comprising the steps of:
A) providing a central control computer with software adapted to permit a sweepstakes operator to communicate with sweepstakes sponsors so as to permit the sponsors to make the sweepstake available to visitors to their web sites and to permit controlled communication between the sponsors web site and a central control computer,
B) programming the central control computer to analyze the predictions of sweepstakes players in comparison to the actual results of the tournament to determine the winner of the tournament,
C) furnishing prior to each tournament names of golfers expected to participate in the tournament,
D) with respect to each tournament, requiring each sweepstakes player to:
1) communicate with a sponsor's web site with an electronic device,
2) provide the web site via the electronic device with one or more unique identifiers identifying the sweepstakes player,
3) predict the winner of the tournament and the golfers who will shoot par on the final day of the tournament and to document those predictions with the electronic device,
E) with respect to each tournament, requiring the sponsors to transmit to the central control computer via the communication network the predictions of sweepstakes players documented at the sponsor's web sites,
F) with respect to each tournament, entering the results of the tournament into the control computer and
G) with respect to each tournament, reporting the sweepstakes winner or winners.

2. The method as in claim 1 wherein the communication network is the Internet.

3. The method set forth in claim 1 wherein said electronic device is a personnel computer.

4. The method set forth in claim 1 wherein said electronic device is a personnel computer.

5. The method set forth in claim 1 wherein said electronic device is a smart phone.

6. The method set forth in claim 1 wherein said personnel identifier is a social security number.

7. The method set forth in claim 1 wherein said personnel identifier is a password.

8. The method set forth in claim 1 wherein said personnel identifier is a drivers' license number.

9. The method as in claim 1 wherein the personnel identifier is a computer generated special code.

10. The method as in claim 9 wherein the sponsors purchase a number of the special codes from the sweepstakes operator and make them available to their customers, clients and/or web site visitors.

11. The method as in claim 10 wherein potential sweepstakes player purchase special codes from the sweepstakes operator.

12. The method set forth in claim 1 wherein participation in the sweepstakes is free.

13. The method as in claim 1 wherein a plurality of sponsors program their web sites allow sweepstakes players to view advertisements of the sponsors products or services.

14. The method as in claim 1 wherein sweepstakes players are required to pay a fee to participate.

15. The method in claim 1 wherein sweepstakes players choose whether or not they pay a fee to play the sweepstakes, but the prize for the winner or winners is greater if they choose to pay the fee.

16. The method as in claim 1 wherein the sweepstakes winner is determined based on a point system.

17. The method as in claim 16 wherein 10 points is given for a correct prediction of the tournament winner, 2 points are given for a correct prediction of a par shooter and 1 point is subtracted for an incorrect prediction of a par shooter.

18. The method as in claim 18 wherein an additional 5 points is given for a correct prediction of the winner's tournament score.

19. The method as in claim 14 wherein an additional 10 points is given for the correct prediction of both the winner and his tournament score.

20. The method as in claim 1 wherein the web site of the operator of the sweepstake is programmed so that sweepstakes player can make their predictions directly through the web site of the operator of the sweepstakes.
